(19) United States
(12) Patent Application Publication
(10) Pub. No.: US 2022/0069595 A1
(43) Pub. Date: Mar. 3, 2022

(54) LAPTOP CASE WITH CHARGING PAD

(71) Applicant: Koi Charging LLC, West Chester, PA (US)

(72) Inventors: ERIC YU, West Chester, PA (US); Daniel Joseph Cantando, III, West Chester, PA (US)

(21) Appl. No.: 17/407,323

(22) Filed: Aug. 20, 2021

Related U.S. Application Data
(60) Provisional application No. 63/070,995, filed on Aug. 27, 2020.

(51) Int. Cl. H02J 7/00; H02J 50/10; H02J 7/02; G06F 1/16

(52) U.S. Cl. CPC H02J 7/0042; G06F 1/1628; H02J 7/02; H02J 50/10

(57) ABSTRACT

Exemplary embodiments are directed to a laptop case. The laptop case include a top section configured to at least partially receive a screen section of a laptop, a bottom section configured to at least partially receive a base section of the laptop, and a charging pad connected to the bottom section. The charging pad is configured to be electrically coupled with at least one of the laptop or an external battery to provide power to the charging pad.

### CROSS-REFERENCE TO RELATED APPLICATIONS

This application claims the benefit of co-pending U.S. Provisional Patent Application No. 63/070,995, which was filed on Aug. 27, 2020. The entire content of the foregoing provisional application is incorporated herein by reference.

### TECHNICAL FIELD

The present disclosure relates to a laptop case and, in particular, to a laptop case including a charging pad incorporated into the laptop case for selectively charging a mobile device.

### BACKGROUND

Protective cases are generally used for laptops to prevent scratches or damage to the laptop during use or transport. Users typically also have a mobile device that can be charged by connecting the mobile device to the laptop via a dedicated charging cable. However, the charging cable for the mobile device and a separate charging cable for the laptop can become tangled, creating difficulties for the user. In addition, if the user forgets the charging cable for the mobile device, it is impossible to use the laptop as a source for charging the mobile device.

Thus, a need exists for laptop case that provides convenient charging means for a mobile device without the need for a charging cable. These and other needs are addressed by the laptop case of the present disclosure.

### SUMMARY

In accordance with embodiments of the present disclosure, an exemplary laptop case is provided. The laptop case includes a top section configured to at least partially receive a screen section of a laptop, a bottom section configured to at least partially receive a base section of the laptop, and a charging pad pivotally connected to the bottom section. The charging pad includes an electrical connector extending therefrom. The electrical connector is configured to be electrically coupled with an electrical port of the laptop to provide power to the charging pad. With modern mobile devices capable of wireless charging, the charging pad can be selectively extended from the laptop case to charge the mobile device when needed without having to use a dedicated mobile device charging cable. The charging pad incorporated into the laptop case therefore provides a convenient means for charging the mobile device while using the battery for the laptop as a source of power for the charging pad.

In some embodiments, the top section can include one or more lips (e.g., projections) at the perimeter of the top section, the one or more lips configured to wrap or snap around an edge of the screen section of the laptop. In some embodiments, the bottom section can include one or more lips at the perimeter of the bottom section, the one or more lips configured to wrap or snap around an edge of the base section of the laptop. In some embodiments, the laptop case can include support legs extending from a bottom surface of the bottom section.

The laptop case can include a hinge (e.g., a pivot structure) connecting the charging pad to the bottom section. The charging pad is capable of wirelessly charging a mobile device. The charging pad is capable of being pivoted into a stored position immediately below the bottom section, and an extended position laterally offset from the bottom section. In some embodiments, a bottom surface of the bottom section can include a recessed area formed therein. The recessed area can be complementary in depth, width and length to the charging pad. In such embodiments, the charging pad is capable of being pivoted into a stored position within the recessed area of the bottom section. In the stored position, the charging pad does not extend beyond a plane defined by the bottom surface of the bottom section.

In accordance with embodiments of the present disclosure, an exemplary laptop case is provided. The laptop case includes a bottom section configured to at least partially receive a base section of a laptop, and a charging pad pivotally connected to the bottom section. The charging pad includes an electrical connector extending therefrom. The electrical connector is configured to be electrically coupled with an electrical port of the laptop to provide power to the charging pad.

In some embodiments, the laptop case can include a top section configured to at least partially receive a screen section of a laptop. The top section can include one or more lips at the perimeter of the top section, the one or more lips configured to wrap or snap around an edge of the screen section of the laptop. The bottom section can include one or more lips at the perimeter of the bottom section, the one or more lips configured to wrap or snap around an edge of the base section of the laptop.

The laptop case can include a hinge connecting the charging pad to the bottom section. The charging pad is capable of being pivoted into a stored position immediately below the bottom section, and an extended position laterally offset from the bottom section. In some embodiments, a bottom surface of the bottom section can include a recessed area formed therein. The recessed area can be complementary in depth, width and length to the charging pad. In such embodiments, the charging pad is capable of being pivoted into a stored position within the recessed area of the bottom section. In the stored position, the charging pad does not extend beyond a plane defined by the bottom surface of the bottom section.

In accordance with embodiments of the present disclosure, an exemplary laptop case is provided. The laptop case includes a top section configured to at least partially receive a screen section of a laptop, a bottom section configured to at least partially receive a base section of the laptop, and a charging pad connected to the bottom section. The charging pad is configured to be electrically coupled with at least one of the laptop or an external battery to provide power to the charging pad.

In some embodiments, the charging pad can be pivotally connected to the bottom section at a hinge such that the charging pad pivots between a stored position and an extended position. In such embodiments, in the stored position, the charging pad is positioned immediately below the bottom section, and in the extended position, the charging pad is positioned laterally offset from the bottom section. In the stored position, the charging pad does not extend beyond a plane defined by a bottom surface of the bottom section.

In some embodiments, the charging pad can be slidably connected to the bottom section such that the charging pad slides relative to the bottom section between a stored position and an extended position. In such embodiments, in the stored position, the charging pad is positioned immediately below the bottom section, and wherein in the extended position, the charging pad is positioned laterally offset from the bottom section.

The top section can include one or more lips at the perimeter of the top section, the one or more lips configured to wrap or snap around an edge of the screen section of the laptop. The bottom section can include one or more lips at the perimeter of the bottom section, the one or more lips configured to wrap or snap around an edge of the base section of the laptop. The charging pad is adapted for wirelessly charging a mobile device (e.g., a mobile phone, a smart device, or the like).

In some embodiments, a bottom surface of the bottom section can include a recessed area formed therein, and the recessed area can be complementary in depth, width and length to the charging pad. In some embodiments, the laptop case can include the external battery detachably coupled to the bottom section. In some embodiments, the charging pad (e.g., charging pad assembly) can include a housing with a hollow interior space, and guides on opposing sides of the hollow interior space. In such embodiments, the guides can include inwardly directed grooves complementary to side edges of the charging pad to allow for sliding of the charging pad along the inwardly directed grooves. In such embodiments, the guides can include two or more clips configured to engage with complementary grooves formed in the side edges of the charging pad to maintain a position of the charging pad within the housing. In some embodiments, the charging pad can include a groove formed in a top surface of the charging pad near a front edge, the groove providing a grip surface for pulling the charging pad from the housing.

In accordance with embodiments of the present disclosure, an exemplary laptop case is provided. The laptop case includes a bottom section configured to at least partially receive a base section of a laptop, and a charging pad connected to the bottom section. The charging pad is configured to be electrically coupled with at least one of the laptop or an external battery to provide power to the charging pad.

The bottom section can include one or more lips at the perimeter of the bottom section, the one or more lips configured to wrap or snap around an edge of the base section of the laptop. In some embodiments, the charging pad can be pivotally connected to the bottom section at a hinge such that the charging pad pivots between a stored position and an extended position. In some embodiments, the charging pad can be slidably connected to the bottom section such that the charging pad slides relative to the bottom section between a stored position and an extended position. In some embodiments, in the stored position, the charging pad does not extend beyond a plane defined by the bottom surface of the bottom section.

In accordance with embodiments of the present disclosure, an exemplary method of charging a mobile device with a wireless charger is provided. The method includes providing a laptop case. The laptop case includes a top section configured to at least partially receive a screen section of a laptop, a bottom section configured to at least partially receive a base section of the laptop, and a charging pad connected to the bottom section. The method includes electrically coupling the charging pad to at least one of the laptop or an external battery to provide power to the charging pad. The method includes wirelessly charging the mobile device with the charging pad.

Other objects and features will become apparent from the following detailed description considered in conjunction with the accompanying drawings. It is to be understood, however, that the drawings are designed as an illustration only and not as a definition of the limits of the invention.

### BRIEF DESCRIPTION OF THE DRAWINGS

To assist those of skill in the art in making and using the disclosed laptop case, reference is made to the accompanying figures, wherein:

FIG. 1 is a front view of an exemplary laptop case according to the present disclosure including a flip out charging pad in a stored position.

FIG. 2 is a rear view of an exemplary laptop case of FIG. 1.

FIG. 3 is a top view of an exemplary laptop case of FIG. 1.

FIG. 4 is a bottom view of an exemplary laptop case of FIG. 1.

FIG. 5 is a left side view of an exemplary laptop case of FIG. 1.

FIG. 6 is a right side view of an exemplary laptop case of FIG. 1.

FIG. 7 is a bottom perspective view of an exemplary laptop case of FIG. 1 with a flip out charging pad in an extended position.

FIG. 8 is a bottom perspective view of an exemplary laptop case of FIG. 1 with a flip out charging pad in a stored position.

FIG. 9 is a bottom perspective view of an exemplary laptop case of the present disclosure with a flip out charging pad in an extended position.

FIG. 10 is a bottom perspective view of an exemplary laptop case of FIG. 9 with a flip out charging pad in a stored position.

FIG. 11 is a front perspective view of an exemplary laptop case according to the present disclosure including a slide out charging pad in a stored position.

FIG. 12 is a side view of an exemplary laptop case of FIG. 11.

FIG. 13 is a front view of an exemplary laptop case of FIG. 11.

FIG. 14 is a bottom view of an exemplary laptop case of FIG. 11.

FIG. 15 is a bottom, partially transparent view of an exemplary laptop case of FIG. 11.

FIG. 16 is a front perspective view of an exemplary laptop case of FIG. 11 including a slide out charging pad in an extended position.

FIG. 17 is a top view of an exemplary laptop case of FIG. 16.

FIG. 18 is a bottom view of an exemplary laptop case of FIG. 16.

FIG. 19 is a bottom, partially transparent view of an exemplary laptop case of FIG. 16.

FIG. 20 is a perspective, partially transparent view of an exemplary charging pad assembly according to the present disclosure including a charging pad in a stored position.

FIG. 21 is a perspective, partially transparent view of an exemplary charging pad assembly of FIG. 20 including a charging pad in an extended position.

FIG. 22 is a top, partially transparent view of an exemplary charging pad assembly of FIG. 20.

FIG. 23 is a perspective, partially transparent view of an exemplary charging pad of a charging pad assembly of FIG. 20 according to the present disclosure.

FIG. 24 is a perspective, partially transparent view of an exemplary charging pad of a charging pad assembly of FIG. 20 according to the present disclosure.

FIG. 25 is a perspective, partially transparent view of exemplary guides of a charging pad assembly of FIG. 20 according to the present disclosure.

FIG. 26 is a perspective, partially transparent view of exemplary guides of a charging pad assembly of FIG. 20 according to the present disclosure.

FIG. 27 is a perspective view of an exemplary laptop case according to the present disclosure including a slide out charging pad in a stored position and an external battery.

FIG. 28 is a bottom perspective view of an exemplary laptop case of FIG. 27.

FIG. 29 is a top view of an exemplary laptop case of FIG. 27.

FIG. 30 is a bottom view of an exemplary laptop case of FIG. 27.

FIG. 31 is a right side view of an exemplary laptop case of FIG. 27.

FIG. 32 is a left side view of an exemplary laptop case of FIG. 27.

### DESCRIPTION OF EXEMPLARY EMBODIMENTS

The present disclosure provides laptop cases that conveniently incorporate a charging pad for wirelessly charging a mobile device. The charging pad can be selectively extended from the housing of the laptop case (e.g., pivoted outward, slid outward, or the like) to provide a charging surface for the mobile device. In the stored position, the charging pad can be carefully retracted and protected by a surrounding housing. An electrical connection between the charging pad and the laptop through the case provides power to the charging pad. The laptop case can thereby provide protection to the laptop, while simultaneously allowing for charging of a mobile device without the need for a dedicated mobile device cable. It should be understood that one or more components or features of the laptop cases discussed herein can be interchanged and/or combined, and such interchanging or combining is envisioned as part of the present disclosure.

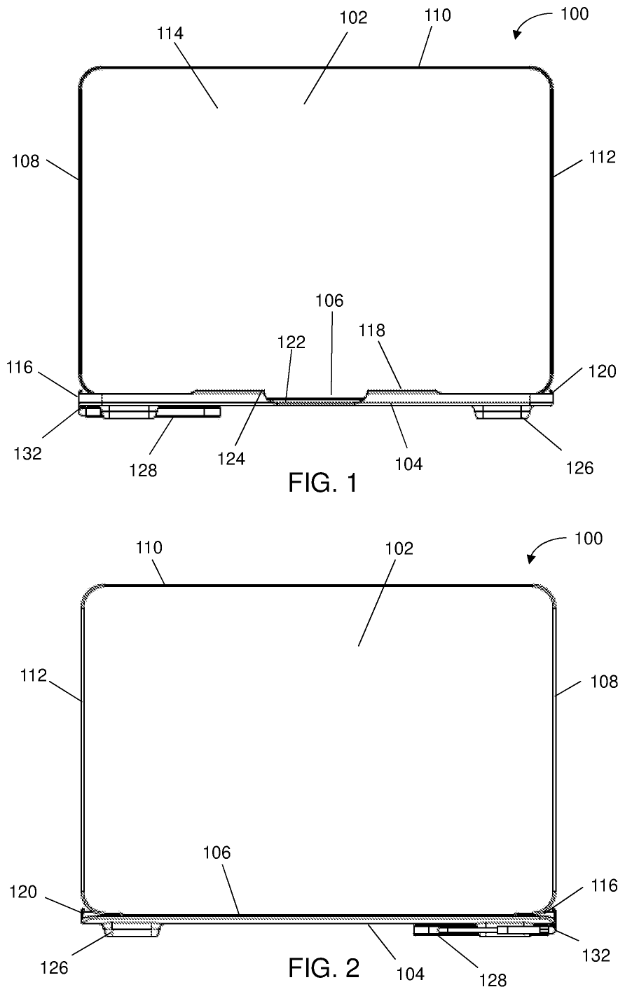

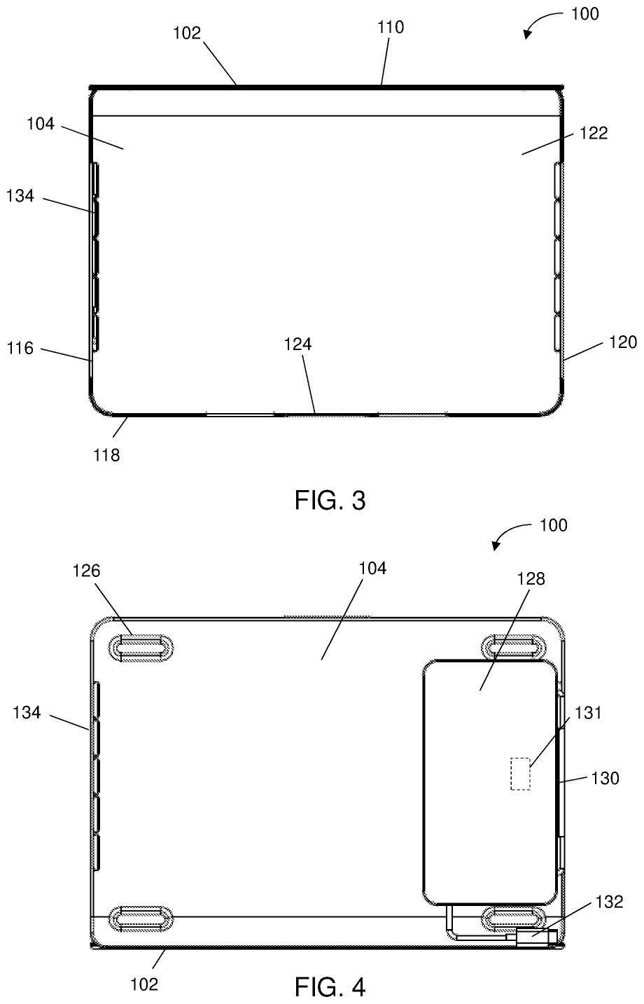

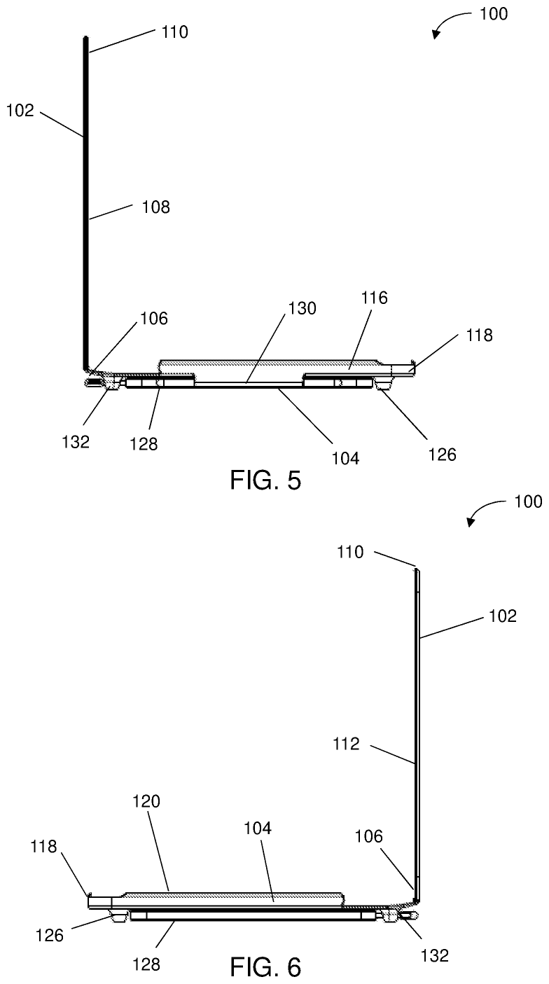

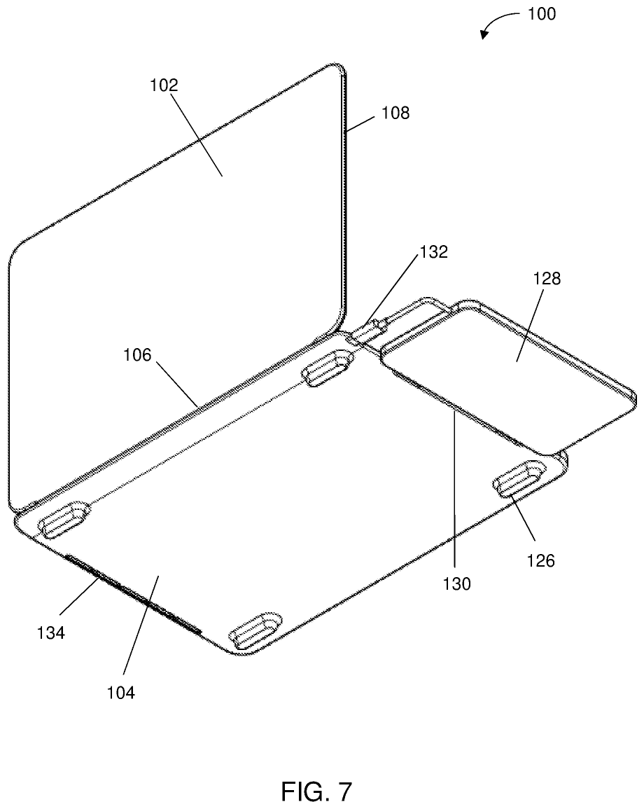

FIGS. 1-8 are front, rear, top, bottom, side and perspective views of an exemplary laptop case 100 of the present disclosure. The laptop case 100 includes a top section 102 and a bottom section 104. In some embodiments, the laptop case 100 can include only a bottom section 104. The top section 102 is connected to the bottom section 104 at a pivot joint 106 allowing for movement of the top section 102 between an open position and a closed position (e.g., when a laptop received by the case 100 is opened and closed). In some embodiments, the pivot joint 106 can be in the form of a hinge. In some embodiments, the pivot joint 106 can be formed from a substantially continuous and flexible material extending between and forming the top and bottom sections 102, 104 to permit bending and pivoting at the pivot joint 106. For example, the top section 102, bottom section 104 and pivot joint 106 can be formed from the same material, e.g., a rubber, silicone, or the like. In some embodiments, the top and bottom sections 102, 104 can be formed from a rigid material (e.g., plastic, or the like). The top and bottom sections 102, 104 serve to protect the laptop received by the case 100 from scratches and can absorb the shock of dropping the laptop.

The top section 102 includes one or more lips 108, 110, 112 (e.g., projections) along the perimeter extending substantially perpendicularly from the flat inner surface 114 of the top section 102. The bottom section 104 includes one or more lips 116, 118, 120 along the perimeter extending substantially perpendicularly from the flat inner surface 122 of the bottom section 104. The top section 102 is configured to receive the screen section of the laptop with the lips 108, 110, 112 at least partially wrapping or snapping around edges of the screen section of the laptop to maintain the top section 102 detachably engaged with the laptop.

The bottom section 104 is configured to receive the base section of the laptop with the lips 116, 118, 120 at least partially wrapping or snapping around edges of the base section of the laptop to maintain the bottom section 104 detachably engaged with the laptop. In some embodiments, the lips 108, 110, 112, 116, 118, 120 can curve slightly inwardly to provide a snap fit around the corresponding edges of the laptop, thereby ensuring that the laptop case 100 is maintained in the attached position relative to the laptop. The top and bottom sections 102, 104 thereby protect the exterior surfaces of the laptop from potential damage. In some embodiments, the lip 118 can include a central cutout 124 configured to substantially align with the trackpad of the laptop, the cutout 124 providing clearance for use of the trackpad.

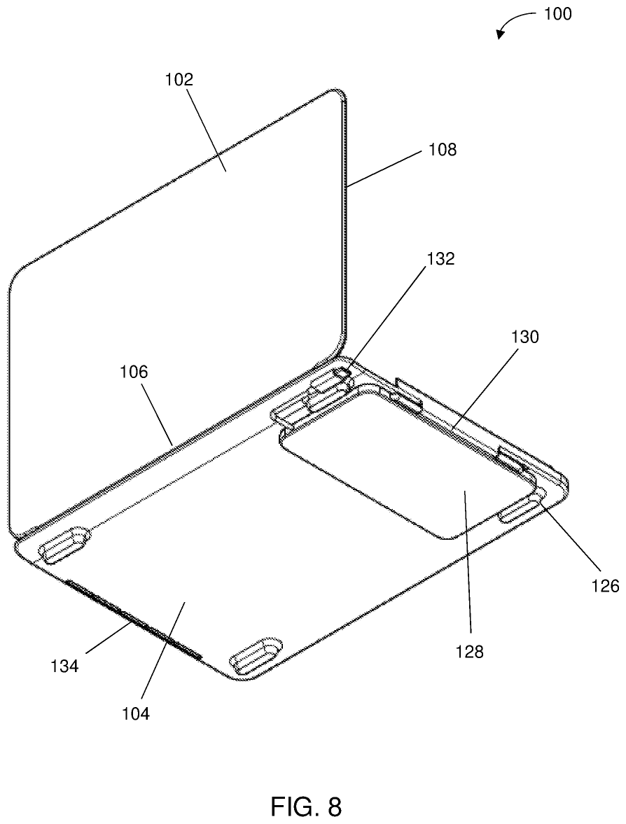

In some embodiments, the laptop case 100 can include four or more support legs 126 extending perpendicularly from the bottom surface of the bottom section 104. The support legs 126 can be formed from a flexible or shock-absorbing material (e.g., rubber, or the like), and provide additional protection to the laptop when the laptop is being placed on a rigid surface. The height of the support legs 126 (as measured from the bottom surface of the bottom section 104) can be selected to be greater than the thickness of the charging pad 128 of the laptop case 100. The greater height of the support legs 126 ensures that when the charging pad 128 is positioned in the stored configuration immediately below the bottom section 104, the support legs 126 maintain a distance between the charging pad 128 and the rigid surface upon which the laptop case 100 is positioned (see, e.g., FIG. 8). Damage to the charging pad 128 is thereby prevented.

The charging pad 128 is pivotally coupled relative to the bottom section 104 at a hinge 130. In some embodiments, two or more hinges can be used. The charging pad 128 can therefore be oriented in an extended position for use (see, e.g., FIG. 7), and can be pivoted into a stored position underneath the bottom section 104 when not in use (see, e.g., FIG. 8). In the extended position, the charging pad 128 is laterally offset from and disposed adjacent to a side of the bottom section 104. In some embodiments, in the extended position, the bottom surface of the charging pad 128 can be substantially aligned with the bottom surface of the bottom section 104. In the stored position, the charging pad 128 is disposed immediately below the bottom section 104. The charging pad 128 includes an electrical connector 132 (e.g., a universal serial bus (USB) connector, or the like, and associated cable) extending from the charging pad 128.

The bottom section 104 can include one or more openings or holes 134 formed therein on either side of the bottom section 104. The holes 134 can provide a ventilation pathway for the base section of the laptop. One or more holes 134 can also be used as a pathway for extending the electrical connector 134 through the base section 104 to connect the electrical connector 132 with a corresponding USB slot in the laptop. In some embodiments, the base section 104 can include a dedicated hole for the electrical connector 132. In some embodiments, the electrical connector 132 can be permanently disposed within the perimeter of the base section 104 with the cable allowing the charging pad 128 to be positioned in the stored position. The flexible cable associated with the charging pad 128 allows the electrical connector 132 to be extended as needed depending on the position of the corresponding USB slot in the laptop.

A user can thereby position the laptop within the top and bottom sections 102, 104 of the laptop case 100, and the electrical connector 132 can be electrically connected to the USB slot of the laptop. The laptop provides power to the charging pad 128 through the electrical connector 132. If charging of a mobile device (e.g., a cellular phone, or the like) is desired, the charging pad 128 can be oriented in the extended position and the mobile device can be placed on the charging pad 128 to initiate wireless charging. An additional/dedicated charging cable for the mobile device is therefore not needed. Once the mobile device has been charged, the charging pad 128 can be pivoted into the stored position below the bottom section 104. In some embodiments, upon pivoting the charging pad 128 into the stored position, the charging pad 128 can automatically turn off until the charging pad 128 is subsequently pivoted back into the extended position. Such automatic on/off operation can be performed based on sensor information regarding the position of the charging pad 128 (e.g., a position sensor 131 as seen in FIG. 4), and the charging pad 128 can remain electrically connected to the laptop via the electrical connector 132 in both the on and off modes. The laptop case 100 therefore provides convenient charging means for a mobile device without the need for additional charging cables.

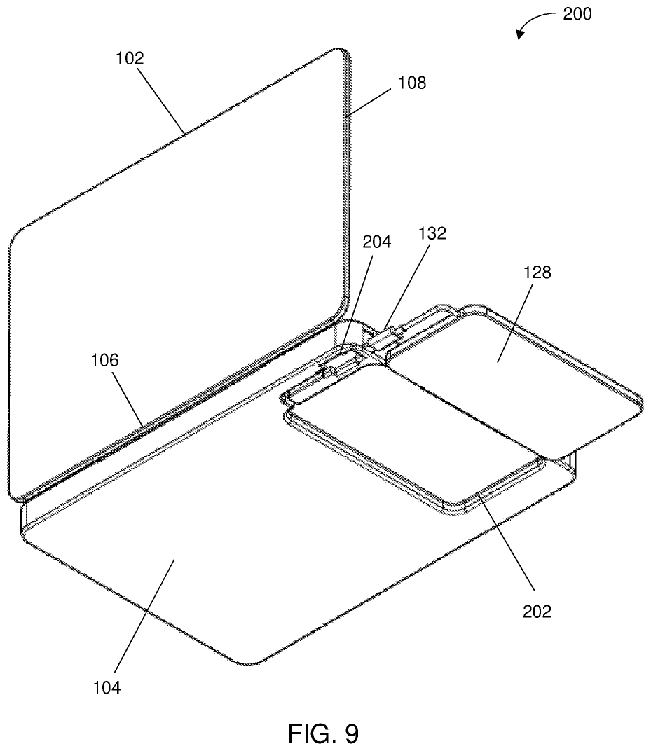

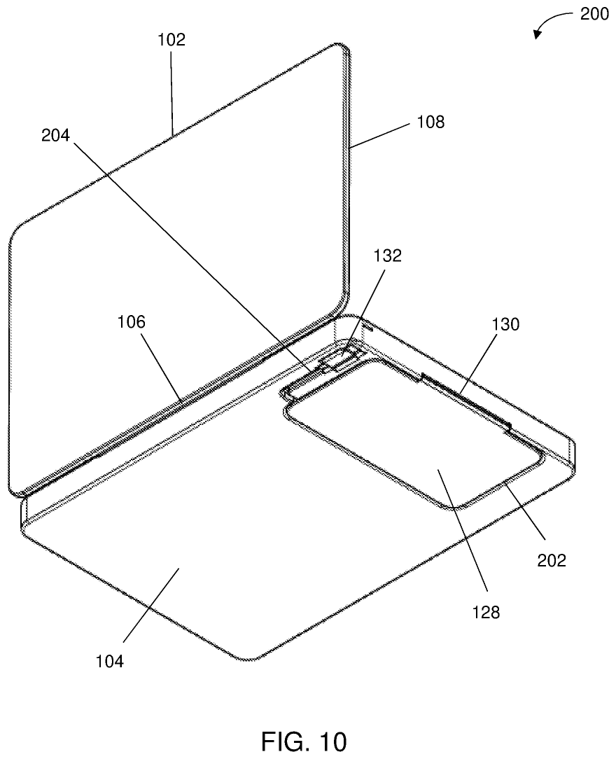

FIGS. 9 and 10 are perspective views of an exemplary laptop case 200 of the present disclosure. The laptop case 200 can be substantially similar in structure and function to the laptop case 100, except for the distinctions noted herein. Rather than having a substantially flap bottom surface of the bottom section 104, the bottom section 104 of the laptop case 200 can include a recessed area 202 complementary to the charging pad 128 and a recessed area 204 configured and dimensioned complementary to the electrical connector 132. In some embodiments, a single recessed area 204 can be formed in the bottom section 104 to accommodate both the charging pad 128 and the electrical connector 132.

The depth of the recessed areas 202, 204 can be dimensioned such that when the charging pad 128 is positioned in the stored position (as shown in FIG. 10), the charging pad 128 and electrical connector 132 do not extend beyond the plane defined by the bottom surface of the bottom section 104. Such stored position of the charging pad 128 and electrical connector 132 can prevent potential damage to these components when transporting the laptop. In the embodiment of FIGS. 9 and 10, the laptop case 200 can optionally include the support legs 126. However, because the charging pad 128 is disposed entirely within the recessed area 202 of the bottom section 104, the support legs 126 are not necessary to elevate the bottom section 104 relative to a rigid surface on which the laptop case 200 is positioned.

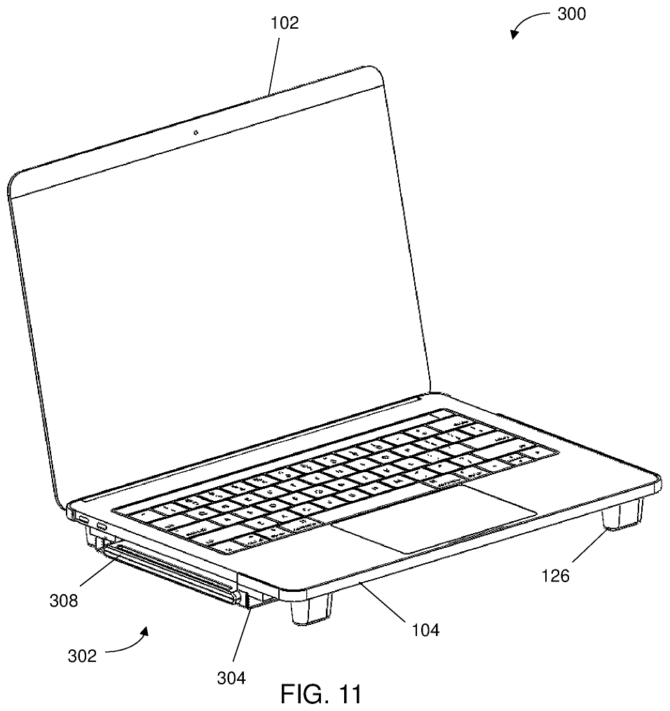

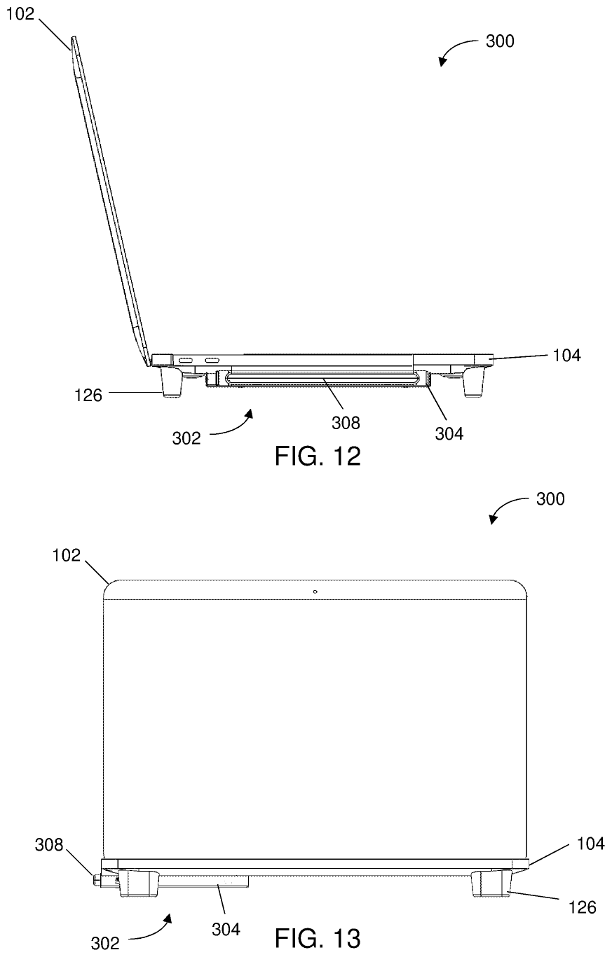

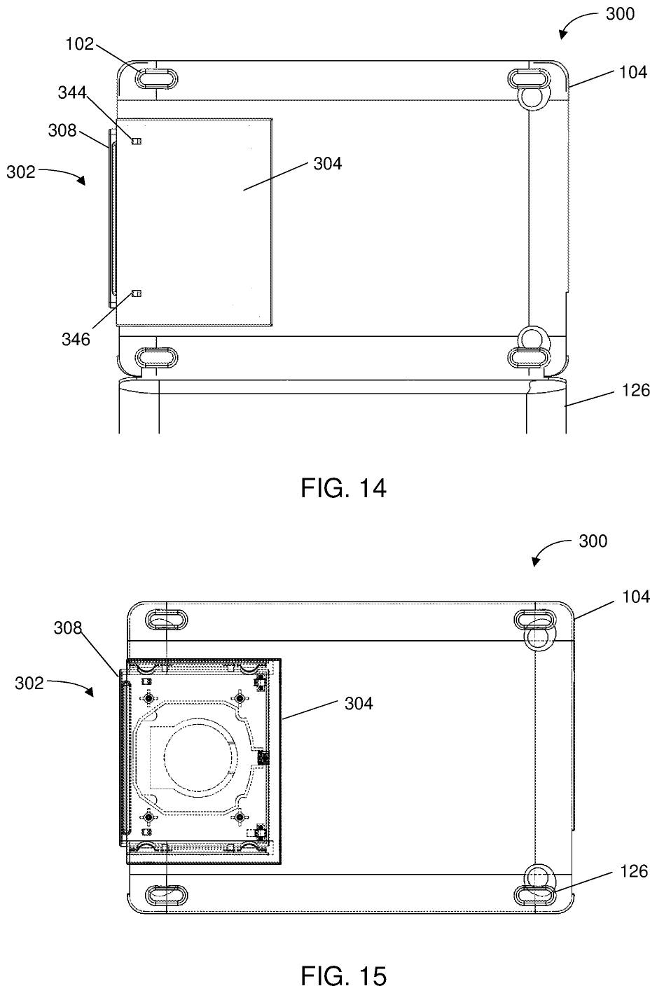

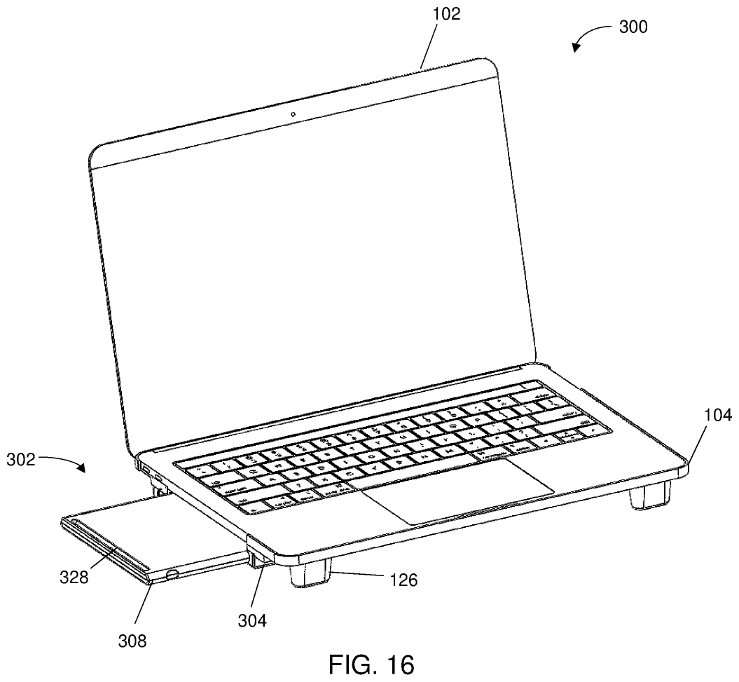

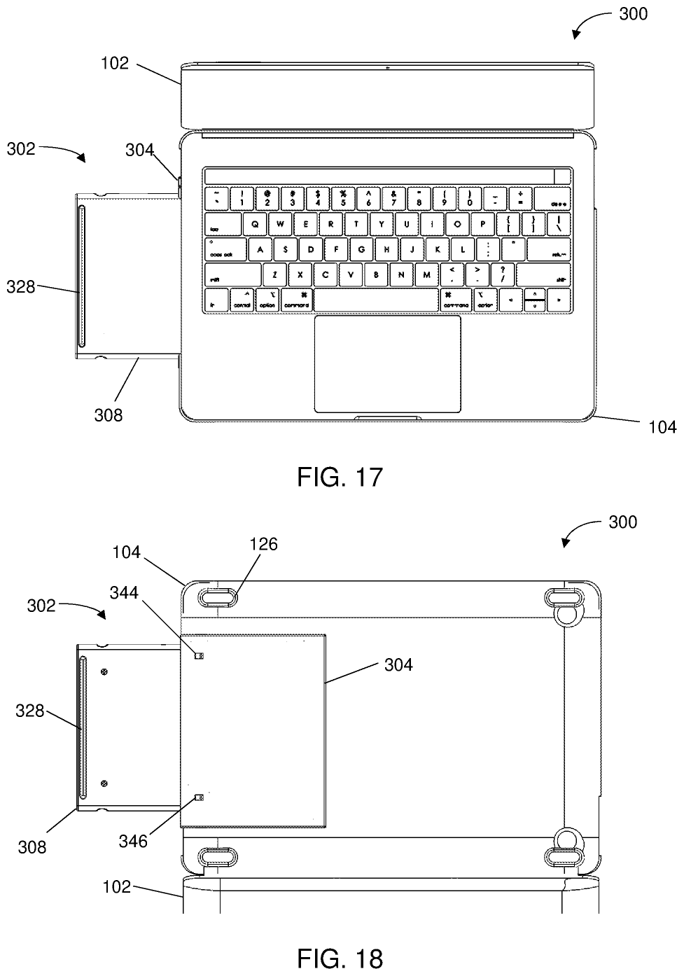

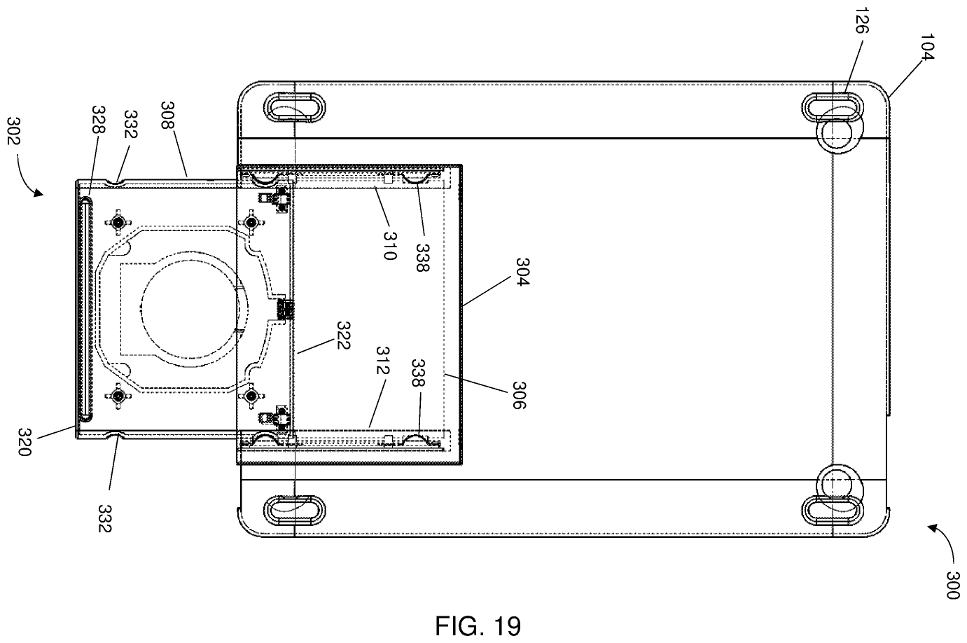

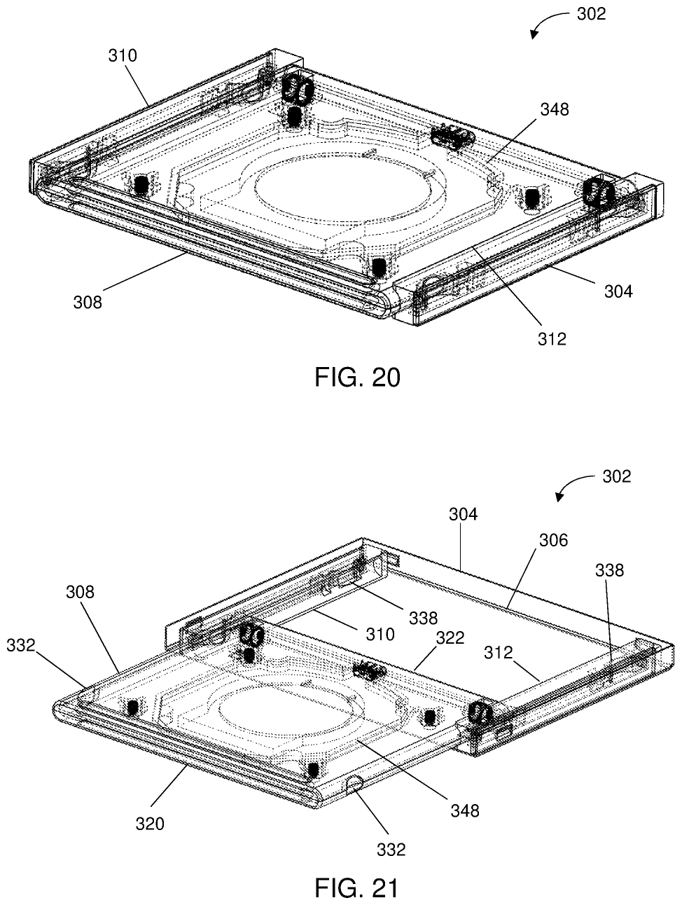

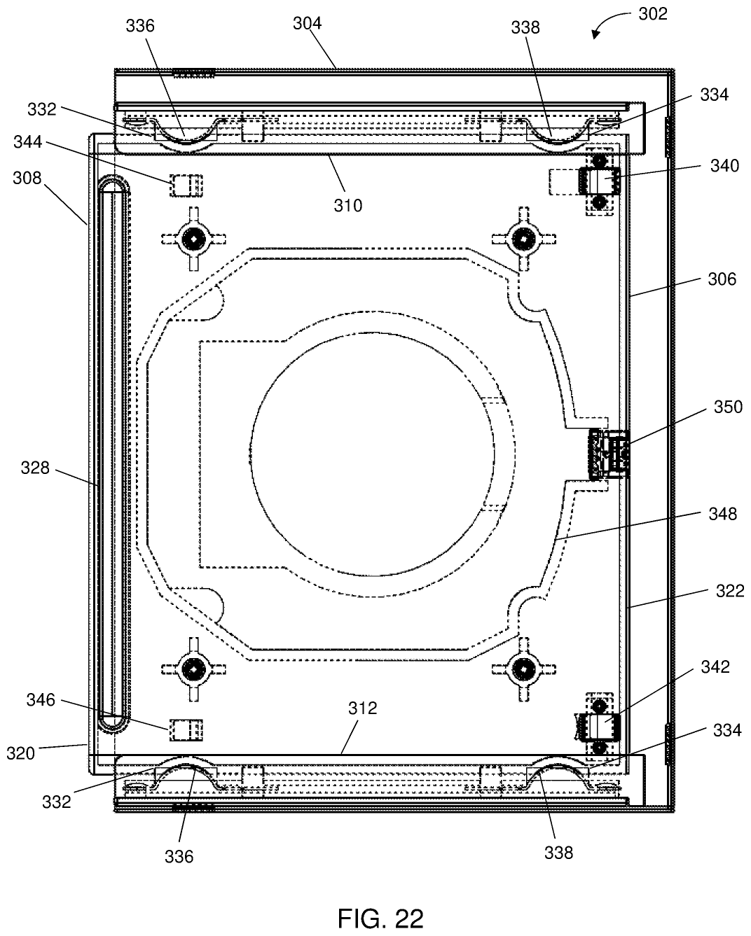

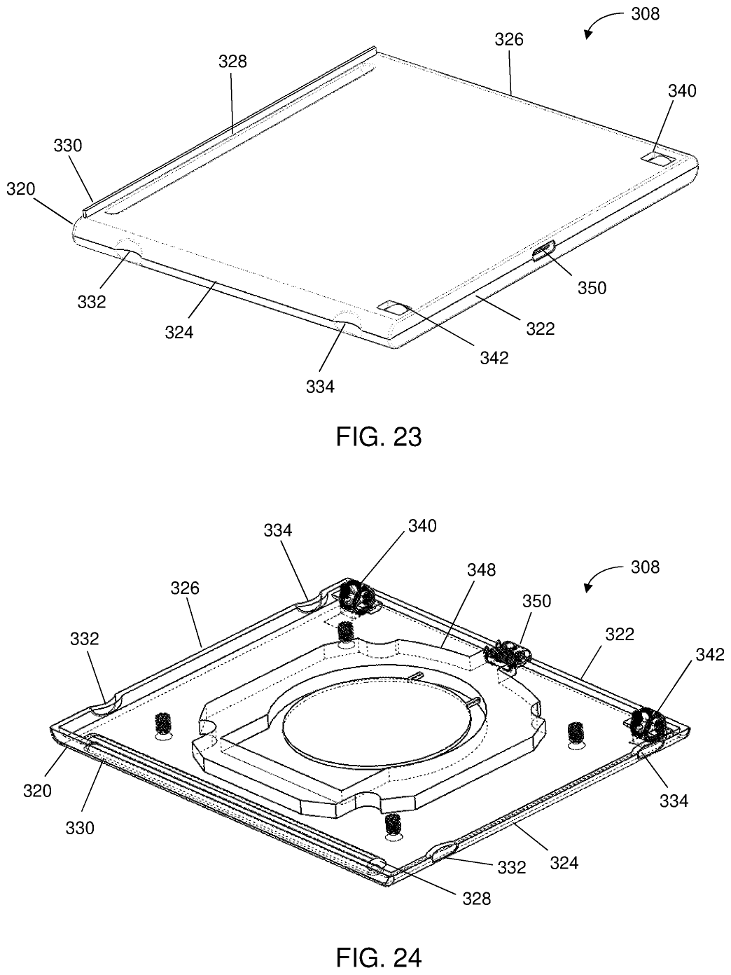

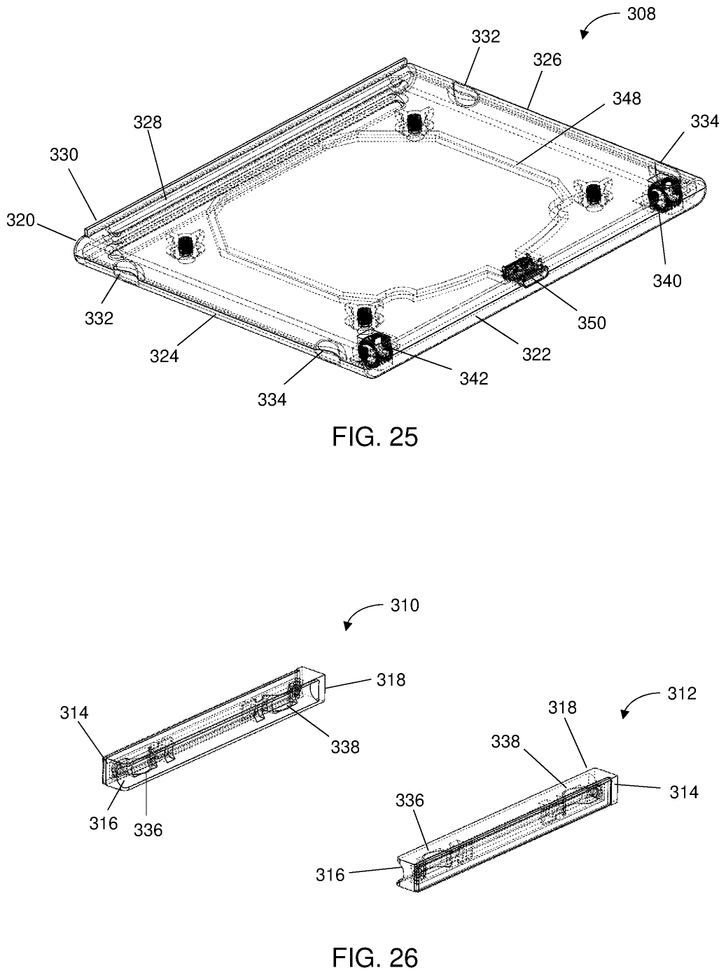

FIGS. 11-19 are perspective, side, front, top and bottom views of an exemplary laptop case 300 of the present disclosure. The laptop case 300 can be substantially similar in structure and function to the laptop cases 100, 200, except for the distinctions noted herein. Therefore, the same reference numbers refer to the same structures. In particular, rather than a flip out design of the charging pad, the laptop case 300 can include a slide out mechanism for movement of the charging pad between an extended and stored position.

The laptop case 300 includes a charging pad assembly 302 coupled to the bottom surface of the bottom section 104 of the laptop case 300. The assembly 302 includes a housing 304 with a hollow interior space 306 configured to slidingly receive at least partially therein the charging pad 308. On opposing sides of the interior space 306, the assembly 302 includes first and second guides 310, 312 that providing guidance to the sliding movement of the charging pad 308. In particular, the interior space 306 generally defines a substantially rectangular configuration such that the charging pad 308 can slide outward and inward laterally relative to the laptop case 300. The guides 310, 312 can be secured to the opposing inner walls of the housing 304 (e.g., front and rear inner walls as viewed relative to the orientation of the laptop case 300 and laptop).

Each guide 310, 312 includes a substantially flat outer wall 314, and an inwardly curved inner wall 316 (e.g., an inner wall with a curve or groove). The curve or groove formed in the inner wall 316 is configured complementary to the edges of the charging pad 308 to allow for sliding of the charging pad 308 along the inner wall 316 (see, e.g., FIG. 26). A front edge of each guide 310, 312 is open to the curve or groove formed in the inner wall 316 to receive the charging pad 308, while the rear edge of each guide 310, 312 includes a solid wall 318 which acts as a stop to prevent further sliding of the charging pad 308.

The charging pad 308 defines a substantially rectangular shape with substantially flat top and bottom surfaces. The thickness of the charging pad 308 corresponds to the curve or groove formed in the inner wall 316 of the guides 310, 312 such that the charging pad 308 can slide within and along the grooves. The charging pad 308 includes a front edge 320 (e.g., an outwardly facing edge), a rear edge 322 (e.g., an inwardly facing edge), and opposing side edges 324, 326 extending between the front and rear edges 320, 322. At or near the front edge 320, the charging pad 308 can include a feature 328 (e.g., a groove, a textured surface, or the like) to assist with gripping and pulling out the charging pad 308 from the housing 304. In some embodiments, the charging pad 308 can include a complementary feature formed in the bottom surface to allow for gripping of the charging pad 308 from both sides, thereby increasing the grip and pull force. In some embodiments, the charging pad 308 can include a protrusion, raised edge or flange 330 extending substantially perpendicularly from the front edge 320 along the majority of the length of the front edge 320. The flange 330 can act as a barrier to prevent the mobile device from sliding off of the charging pad 308. In some embodiments, the flange 330 can be used for pulling the charging pad 308 out of the housing 304 (instead of or in addition to the feature 328).

Each of the side edges 324, 326 includes a first inwardly directed groove 332 and a second inwardly directed groove 334 extending substantially perpendicularly or vertically to the top and bottom surfaces of the charging pad 308. The first grooves 332 can be positioned near/offset from the front edge 320, and the second grooves 334 can be positioned near/offset from the rear edge 322. The grooves 332, 334 are aligned on opposing sides of the charging pad 308. The guides 310, 312 each include spring-loaded protrusions or clips 336, 338 extending from the inner wall 316 in positions and/or spacing complementary to the grooves 332, 334 of the charging pad 308. Each of the clips 336, 338 can define a substantially semi-circular shape complementary to the grooves 332, 334. The combination of the grooves 332, 334 and clips 336, 338 acts as an engagement or locking mechanism, In particular, when the charging pad 308 is retracted into the stored position within the housing 304, the clips 336, 338 can snap into and engage with the respective grooves 332, 334, maintaining the stored position of the charging pad 308 within the housing 304. When use of the charging pad 308 is desired, the user can pull on the feature 328 of the charging pad 308 to overcome the spring force of the clips 336, 338, allowing the charging pad 308 to at least partially slide out of the housing 304. In some embodiments, rather than including springs, the clips 336, 338 can flex based on the pulling force on the charging pad 308, allowing for release of the groove 332, 334 engagement. In some embodiments, in the extended position of the charging pad 308, the clips 338 can engage with the grooves 332 to maintain the charging pad 308 in the extended position (e.g., preventing sliding of the charging pad 308 into the housing 304).

The charging pad 308 can include two springs 340, 342 that are coupled to corresponding engagement structures 344, 346 (e.g., hooks, protrusions, or the like) of the housing 304. The springs 340, 342 can maintain a constant biasing force on the charging pad 308 towards the extended or deployed position. The biasing force of the springs 340, 342 is insufficient to overcome the biasing or engagement force created by the clips 336, 338 within the grooves 332, 334. However, upon disengagement of the clips 336, 338 from the grooves 332, 334, the springs 340, 342 can bias the charging pad 308 outward until the clips 338 engage with the grooves 332 in the fully extended position of the charging pad 308. For example, the user may only need to initially disengage the clips 336, 338 from the grooves 332, 334, and the biasing force of the springs 340, 342 can fully extend the charging pad 308 without further pulling from the user.

The internal mechanical and/or electrical components 348 disposed within the housing of the charging pad 308 allow for wireless charging of the mobile device placed on the top surface of the charging pad 308. The charging pad 308 includes an electrical connector port 350 disposed at the rear edge 322. A cable can be connected to the port 350 at one end and connected to a port (e.g., a USB port) of the laptop to provide power to the charging pad 308. Any excess cable connected to the port 350 can be stored within the hollow interior space 306 of the housing 304. The cable connecting the charging pad 308 to the laptop can thereby be internally stored to prevent any potential disconnection and/or damage to the cable.

Thus, in the stored position, the charging pad 308 can be almost completely inserted within the housing 304 with only the feature 328 extending beyond the housing 304 to allow for gripping of the charging pad 308 for removal. Upon extension of the charging pad 308 from the housing 304, approximately 65-90% of the charging pad 308 can be extended beyond the housing 304 with the remaining area of the charging pad 308 assisting with engagement within the housing 304.

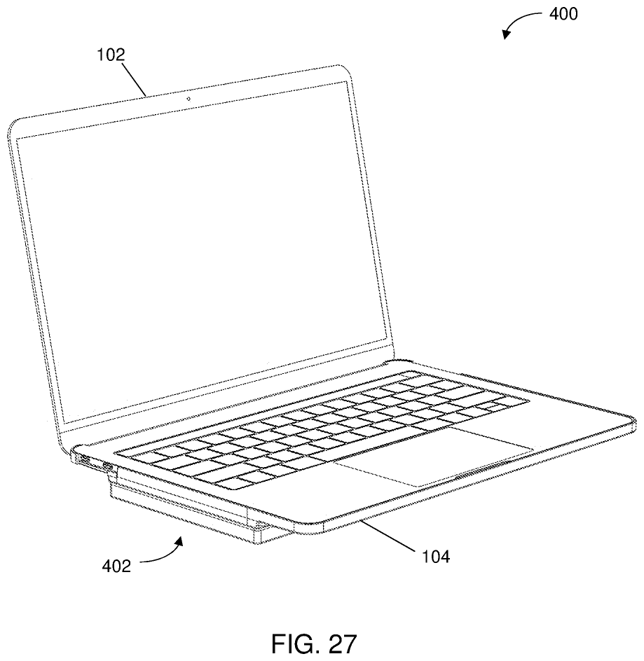

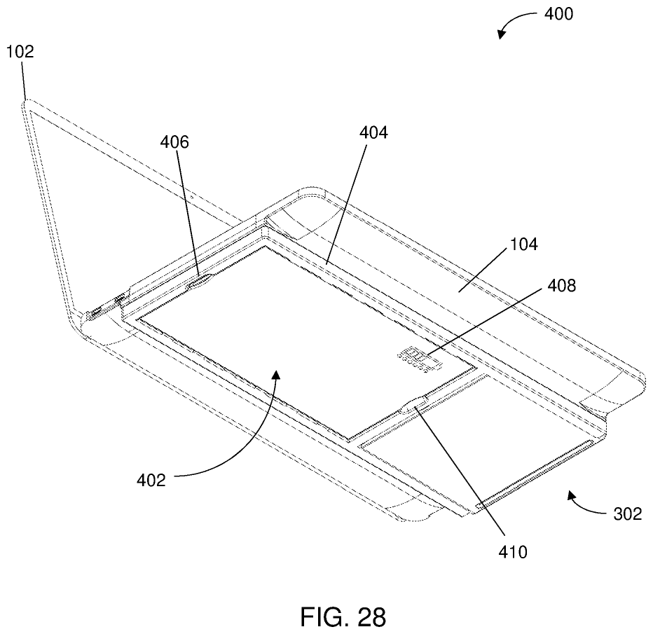

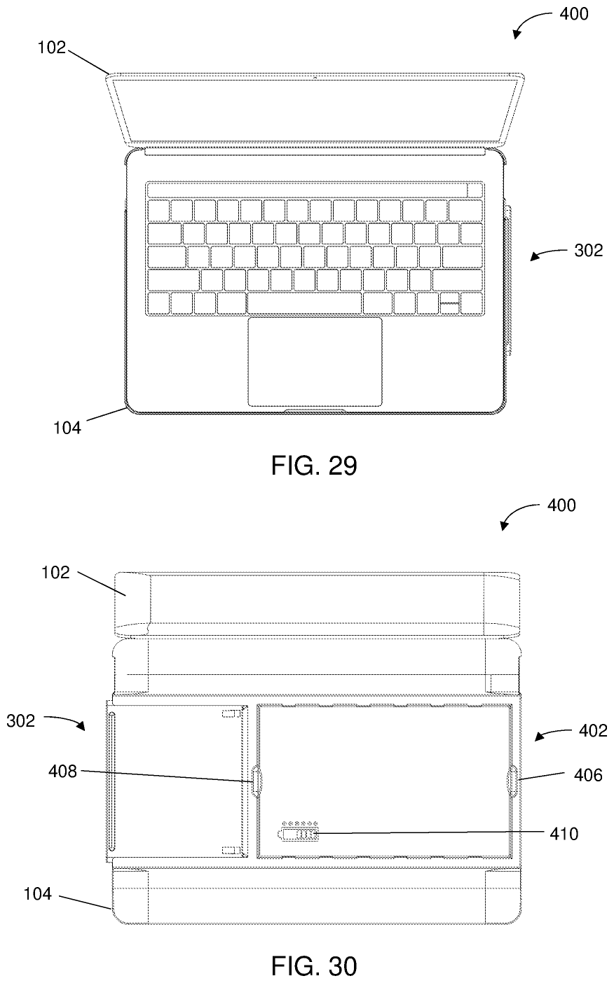

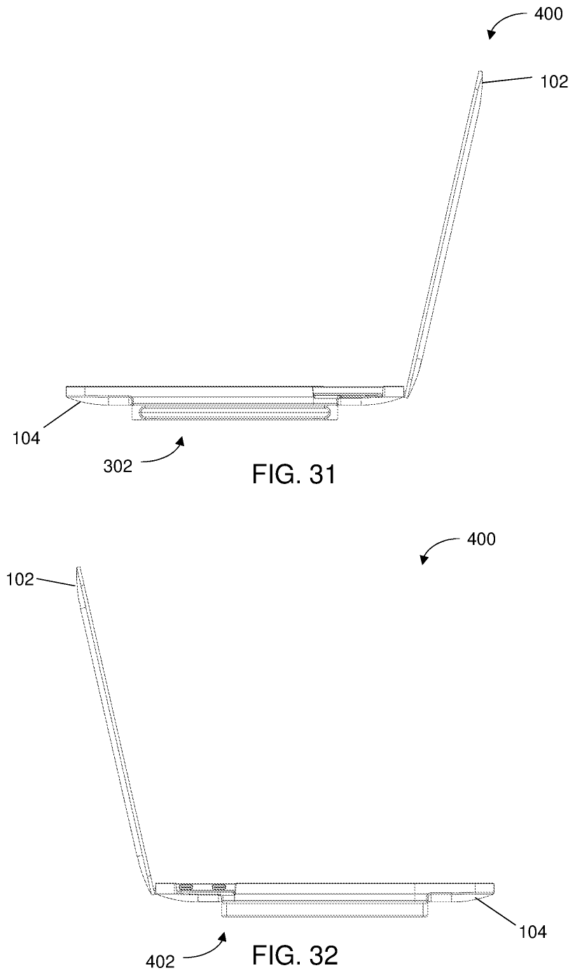

FIGS. 27-32 are perspective, side, top and bottom views of an exemplary laptop case 400 of the present disclosure. The laptop case 400 can be substantially similar in structure and function to the laptop cases 100, 200, 300 except for the distinctions noted herein. Therefore, the same reference numbers refer to the same structures. In particular, in addition to the charging pad assembly 302, in some embodiments, the laptop case 400 can include an external battery 402 electrically and mechanically coupled to the bottom surface of the bottom section 104.

The external battery 402 can define a substantially rectangular configuration, although alternative configurations are envisioned. In some embodiments, the width of the external battery 402 can be substantially equal to the width of the charging pad assembly 302. In some embodiments, the bottom surface of the bottom section 104 can include a recessed area configured to at least partially receive therein the external battery 402. In some embodiments, the laptop case 400 can include a housing 404 formed at the bottom section 104 configured to at least partially receive therein the external battery 402 (and/or the charging pad assembly 302). In some embodiments, the bottommost surface of the external battery 402 and the charging pad assembly 302 can act as the support surface for the laptop case 400. In some embodiments, the laptop case 400 can include support legs 126 extending from the bottom section 104.

The external battery 402 can include engagement or locking clips 406, 408 on opposing sides that can be detachably engaged with the surrounding housing, ensuring that the engaged position of the external battery 402 is maintained. The external battery 402 includes an electrical connection port (not visible) that electrically connects the external battery 402 to the laptop case 400, which further electrically connects the external battery 402 to the laptop. In operation, the external battery 402 can provide power to charge the laptop, and the laptop can provide power to the charging pad assembly 302. When the laptop is connected to another power source, such power source can initially charge the laptop and, once the laptop has reached 100% charging status, the power source can continue to charge the external battery 402. The external battery 402 can include a visual indicator 410 (e.g., one or more light emitting diodes (LEDs)) indicative of the battery charge level of the external battery 402. In some embodiments, the external battery 402 can provide power to the charging pad assembly 302 (instead of power being provided by the laptop). Thus, the laptop case 400 can provide a convenient means for charging a mobile device while simultaneously providing additional charging power to the laptop.

While exemplary embodiments have been described herein, it is expressly noted that these embodiments should not be construed as limiting, but rather that additions and modifications to what is expressly described herein also are included within the scope of the invention. Moreover, it is to be understood that the features of the various embodiments described herein are not mutually exclusive and can exist in various combinations and permutations, even if such combinations or permutations are not made express herein, without departing from the spirit and scope of the invention.

1. A laptop case, comprising:
a top section configured to at least partially receive a screen section of a laptop;
a bottom section configured to at least partially receive a base section of the laptop; and
a charging pad connected to the bottom section, the charging pad configured to be electrically coupled with at least one of the laptop or an external battery to provide power to the charging pad.

2. The laptop case of claim 1, wherein the charging pad is pivotally connected to the bottom section at a hinge such that the charging pad pivots between a stored position and an extended position.

3. The laptop case of claim 2, wherein in the stored position, the charging pad is positioned immediately below the bottom section, and wherein in the extended position, the charging pad is positioned laterally offset from the bottom section.

4. The laptop case of claim 2, wherein in the stored position, the charging pad does not extend beyond a plane defined by a bottom surface of the bottom section. The laptop case of claim 1, wherein the charging pad is slidably connected to the bottom section such that the charging pad slides relative to the bottom section between a stored position and an extended position.

5. The laptop case of claim 4, wherein in the stored position, the charging pad is positioned immediately below the bottom section, and wherein in the extended position, the charging pad is positioned laterally offset from the bottom section.

6. The laptop case of claim 1, wherein the top section includes one or more lips at the perimeter of the top section, the one or more lips configured to wrap or snap around an edge of the screen section of the laptop.

7. The laptop case of claim 1, wherein the bottom section includes one or more lips at the perimeter of the bottom section, the one or more lips configured to wrap or snap around an edge of the base section of the laptop.

8. The laptop case of claim 1, wherein the charging pad is adapted for wirelessly charging a mobile device.

9. The laptop case of claim 1, wherein a bottom surface of the bottom section includes a recessed area formed therein, and the recessed area is complementary in depth, width and length to the charging pad.

10. The laptop case of claim 1, comprising the external battery detachably coupled to the bottom section.

11. The laptop case of claim 1, wherein the charging pad includes a housing with a hollow interior space, and guides on opposing sides of the hollow interior space.

12. The laptop case of claim 11, wherein the guides include inwardly directed grooves complementary to side edges of the charging pad to allow for sliding of the charging pad along the inwardly directed grooves.

13. The laptop case of claim 11, wherein the guides include two or more clips configured to engage with complementary grooves formed in the side edges of the charging pad to maintain a position of the charging pad within the housing.

14. The laptop case of claim 11, wherein the charging pad includes a groove formed in a top surface of the charging pad near a front edge, the groove providing a grip surface for pulling the charging pad from the housing.

15. A laptop case, comprising:
a bottom section configured to at least partially receive a base section of a laptop; and
a charging pad connected to the bottom section, the charging pad configured to be electrically coupled with at least one of the laptop or an external battery to provide power to the charging pad.

16. The laptop case of claim 12, wherein the bottom section includes one or more lips at the perimeter of the bottom section, the one or more lips configured to wrap or snap around an edge of the base section of the laptop.

17. The laptop case of claim 12, wherein the charging pad is pivotally connected to the bottom section at a hinge such that the charging pad pivots between a stored position and an extended position.

18. The laptop case of claim 12, wherein the charging pad is slidably connected to the bottom section such that the charging pad slides relative to the bottom section between a stored position and an extended position.

19. The laptop case of claim 19, wherein in the stored position, the charging pad does not extend beyond a plane defined by the bottom surface of the bottom section.

20. A method of charging a mobile device with a wireless charger, the method comprising:
providing a laptop case, the laptop case including (i) a top section configured to at least partially receive a screen section of a laptop, (ii) a bottom section configured to at least partially receive a base section of the laptop, and (iii) a charging pad connected to the bottom section;
electrically coupling the charging pad to at least one of the laptop or an external battery to provide power to the charging pad; and
wirelessly charging the mobile device with the charging pad.
